(19) United States
(12) Patent Application Publication
(10) Pub. No.: US 2012/0059902 A1
(43) Pub. Date: Mar. 8, 2012

(54) APPARATUS AND METHOD FOR DOWNLOADING DATA IN PORTABLE TERMINAL

(75) Inventor: Sang-Won Kim, Seoul (KR)

(73) Assignee: SAMSUNG ELECTRONICS CO., LTD., Suwon-si (KR)

(21) Appl. No.: 13/198,518

(22) Filed: Aug. 4, 2011

(30) Foreign Application Priority Data
Sep. 7, 2010 (KR) 10-2010-0087295

(51) Int. Cl. G06F 15/16

(52) U.S. Cl. 709/217

(57) ABSTRACT

An apparatus and method for downloading data in the portable terminal. The apparatus is configured to download corresponding data when entering a position supported by a special network upon a reservation download of data in a portable terminal. The apparatus provides a data reservation function in which a network environment set up by a user is applied to the data reservation download function.

### CROSS-REFERENCE TO RELATED APPLICATION(S) AND CLAIM OF PRIORITY

The present application is related to and claims the benefit under 35 U.S.C. §119(a) of a Korean patent application filed in the Korean Intellectual Property Office on Sep. 7, 2010 and assigned Serial No. 10-2010-0087295, the entire disclosure of which is hereby incorporated by reference.

### FIELD OF THE INVENTION

The present invention relates to an apparatus and method for downloading data in a portable terminal, and more particularly to an apparatus and method for downloading data corresponding to a network which is located in the portable terminal after selecting a network for downloading data upon a reservation download associated with data in the portable terminal.

### BACKGROUND OF THE INVENTION

Recently, use of portable terminals has been rapidly expanding due to the portability and convenience. Accordingly, service providers and terminal manufacturers have been competitively developing a portable terminal having more convenient functions in order to secure many users.

For example, a current portable terminal includes functions such as phone books, games, schedulers, short message services, multimedia message services, broadcasting message services, Internet service, e-mail, morning calls and alarms, MP3 players, digital camera, and the like.

Recently, a user collects a variety of information via the Internet in accordance with building the multimedia communication network. As the technology for connecting to the Internet by using the portable terminal is developed, the development of a complex portable terminal (a smart phone) that includes various functions is required.

By meeting the above-mentioned needs, a portable terminal is capable of downloading and playing back MP3 audio data files from the Internet, and downloading applications needed by a user by using a smart phone to support a plurality of applications (e.g., games and banking programs).

However, the portable terminal or smart phone can be promptly download a file or an application wanted a user, because the data download itself incurs much expense, it is intended to reduce a charging incurrence by downloading data at any time when a user is not the traffic congestion.

For above-mentioned data download process, a user of the portable terminal is not able to select a network which a user wants to be downloaded by a reservation download through setting up the time which is downloaded data on a corresponding time after a user designated as a special time.

The above-mentioned problem appears in a portable terminal capable of supporting a plurality of networks. If the portable terminal supports a plurality of networks such as 3G network, WiBro network, and Wi-Fi network, the portable terminal may incur unnecessary usage fees by downloading data via the 3G network in spite of existing free time available in the WiBro network.

Thus, an apparatus and method for selecting a network upon the data reservation download in a portable terminal to solve above-mentioned problem is required.

### SUMMARY OF THE INVENTION

To address the above-discussed deficiencies of the prior art, it is a primary object to provide an apparatus and method for enhancing the efficiency of the data reservation download in a portable terminal so as to solve the above-mentioned problems.

Another aspect of the present invention is to provide an apparatus and method to avoid incurring unnecessary expenses upon the data reservation download in a portable terminal.

Still another aspect of the present invention is to provide an apparatus and method for setting up the order of data download priority per a network in a portable terminal.

In accordance with an aspect of the present invention, an apparatus for downloading data in a portable terminal includes a controller for setting up and managing data to download per a network, and processing to be downloaded data set up in network environment set up.

In accordance with another aspect of the present invention, a method of downloading data in a portable terminal comprises the processes of: setting up data to be downloaded per a network, and downloading data set up in network environment set up.

In accordance with still another aspect of the present invention, an apparatus of downloading data in a portable terminal comprises a controller for detecting the change of the network environment in accordance with movement of the portable terminal; and a data download management unit for setting up and managing data per a network which the portable terminal supports, downloading data by confirming whether data wanted to download via a changed network is or not.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features and advantages of certain exemplary embodiments of the present invention will be more apparent from the following detailed description taken in conjunction with the accompanying drawings, in which:

FIG. 1 is a block diagram illustrating a structure of a portable terminal to support a data reservation downloading function according to the present invention;

FIG. 2 is a flowchart illustrating a process for setting up a network for downloading data in a portable terminal according to the present invention;

FIG. 3 is a flowchart illustrating a process for the reservation download of data selected by a user in a portable terminal according to the present invention;

FIG. 4 is a flowchart illustrating a process for downloading data in accordance with networks in a portable terminal according to an embodiment of the present invention;

FIG. 5A depicts a screen that displays a list of networks supported by a portable terminal according to an embodiment of the present invention;

FIG. 5B illustrates a portable terminal downloading data via networks according to an embodiment of the present invention; and

FIG. 5C illustrates a portable terminal changing a network upon a reservation download according to an embodiment of the present invention.

### DETAILED DESCRIPTION OF THE INVENTION

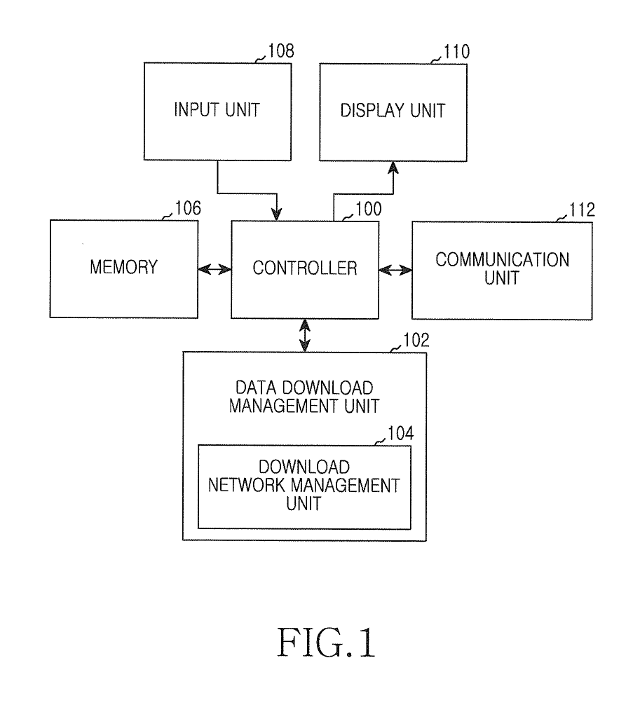

FIGS. 1 through 5C, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged portable terminal. Exemplary embodiments of the present invention will be described herein below with reference to the accompanying drawings. In the following description, well-known functions or constructions are not described in detail since they would obscure the invention in unnecessary detail.

The present invention described hereinafter relates to an apparatus and method avoid incurring unnecessary expenses associated with a data reservation download by setting up order of data download priority per a network in a portable terminal.

FIG. 1 is a block diagram illustrating a structure of a portable terminal configured to support a data reservation downloading function according to the present invention.

Referring to FIG. 1, the portable terminal comprises a controller 100, a data download management unit 102, a memory 106, an input unit 108, a display unit 110, and a communication unit 112. The data download management unit 102 includes a download network management unit 104.

The controller 100 of the portable terminal controls the overall operation of the portable terminal. For example, the controller 100 performs the process and the control for voice communication and data communication, in addition to a general function, sets up a network to download when sensing a reservation download request which is to download data at a corresponding time by changing a data download time in accordance with the present invention.

Also, the controller 100 confirms whether there is data to be downloaded via a corresponding network when generating a change of network, and processes to download data using the changed network upon confirming the existence of data to be downloaded.

The data download management unit 102 manages network information used for downloading data by the control of the controller 100, and downloads data to be downloaded at a user defined time and a scheduled time of a network. That is, the data download management unit 102 confirms the information concerning a network to carry out the download of confirmed data after confirming data to set up the reservation download. The data download management unit 102 confirms a time assigned to a network to download data, and can avoid incurring unnecessary charges by performing the data download only during the assigned time. The data download management unit 102 then performs additional data download via another network that has remaining assigned time or that provides a less costly service. That is, the data download management unit 102 selects a network having remaining free time among a plurality of networks that include a flat rate scheme service or allow some free time downloading. Therefore, the data download management unit 102 downloads a set of data using at least two networks with cost saving.

The download network management unit 104 of the data download management unit 102 manages information of a network used for downloading data, and provides the network information to the data download management unit 102.

The memory 106 is composed of ROM, RAM, and FLASH ROM. The ROM stores microcode of a program for the process and the control of the controller 100 and the data download management unit 102 and all sorts of reference data.

The RAM is a working memory of the controller 100 and stores temporary data generated while performing various programs. The FLASH ROM stores data which may be kept indefinitely and is capable of being updated, such as a telephone book, an originating message, and a receiving message.

The input unit 108 comprises a plurality of function keys such as number key buttons 0 to 9, a menu button, a cancel button, a confirm button, a communication button, a close button, a Internet connecting button, navigation key (or direction key) buttons, character input keys, etc., and provides key input data to the controller 100 in response to a key actuated by a user.

The display unit 110 displays state information generated while operating the portable terminal, characters, video data, still images, and so forth. The display unit 110 can be a color Liquid Crystal Display (LCD). Also, the display unit 110 is equipped with a touch input device, and can be used as an input device when installed on a portable terminal of the touch input type.

The communication unit 112 performs a function to transmit and receive a radio signal inputted and outputted via the antenna (not shown). For example, when transmitting data, the communication unit 112 performs a transmitting function by processing RF after the communication unit 112 performs a channel coding and spreading of transmitting data. When receiving data, the communication unit 112 converts an RF signal into a baseband signal, and performs a function to de-spread and channel decode the baseband signal, and to restore data.

The role of the data download management unit 102 may be performed by the controller 100. FIG. 1 shows a separate data download management unit 102 and controller 100. However, the embodiment shown in FIG. 1 is an exemplary structure for explanatory convenience, and does not limit the scope of the present invention. It will be understood that various modifications of the structure may be implemented within the scope of the present invention by those skilled in the art. For example, the controller 100 can be capable of processing all of the above functions.

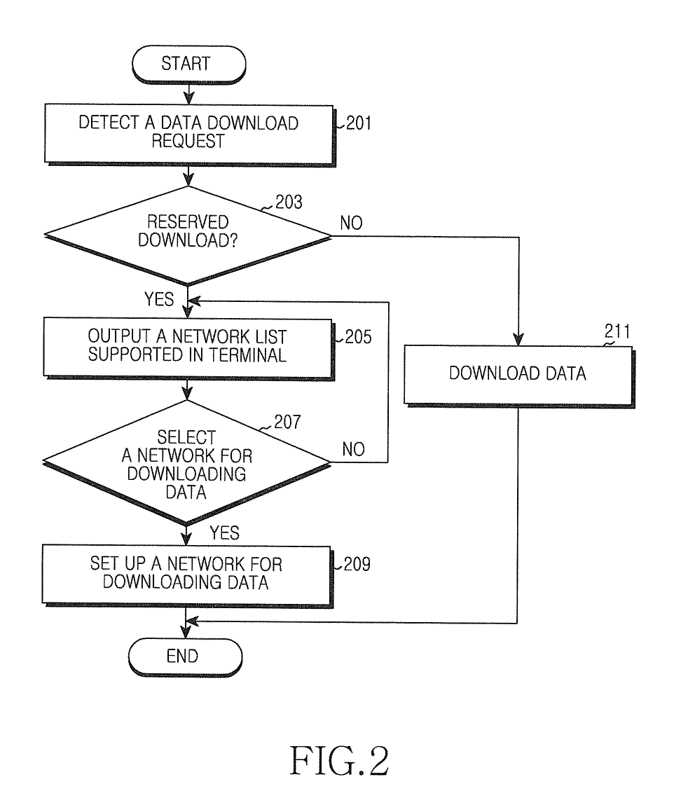

FIG. 2 is a flowchart illustrating a process for setting up a network for downloading data in a portable terminal according to the present invention.

Referring to FIG. 2, the portable terminal first senses a data download request in block 201. Herein, the data download request means to generate an input for downloading selected data (e.g., application, multimedia data, text data, and the like) via the Internet connection (provided via the Internet).

Hereafter, the portable terminal makes progress to block 203, and confirms whether or not the data download request detected in block 203 is a reservation download request. Herein, the reservation download request means a function to download data selected by a user at a corresponding time by setting up a designated time. Generally, the designated time is selected to coincide with a time when traffic is not congested so as to reduce charges associated with the data download.

Upon confirming that the data download request is not a reservation download request in block 203, the portable terminal proceeds to block 211 and performs a general data download process of data selected by the user at the current time.

Alternatively, upon confirming that the data download request is a reservation download request in block 203, the portable terminal proceeds to block 205, and outputs a list of networks supported in the portable terminal. The portable terminal can output also a remaining free usage time of a corresponding network. Some networks sometimes provide some free usage time when a user subscribes to the flat rate scheme service. This is how the portable terminal supports the reservation download per network, and when consuming all free usage time for one network, the portable terminal may download data by selecting another network with remaining free time.

Hereafter, the portable terminal makes progress to block 207, and confirms whether a user selects a network for using the data download or not.

Upon confirming that the user has not selected a network to be used for the data download, the portable terminal performs block 205 again.

Alternatively, when a user selects a network to be used for the data download, the portable terminal proceeds to block 209, and sets up a network to be used for the data download. The portable terminal performs the process of block 209 by storing the information concerning a network selected by a user and the information (e.g., contents information, URL information, and the like) of data selected to be downloaded by a user.

As a result, the portable terminal can download data by using a network which charges minimal or no data usage charges at a special time.

Hereafter, the portable terminal stops this algorithm.

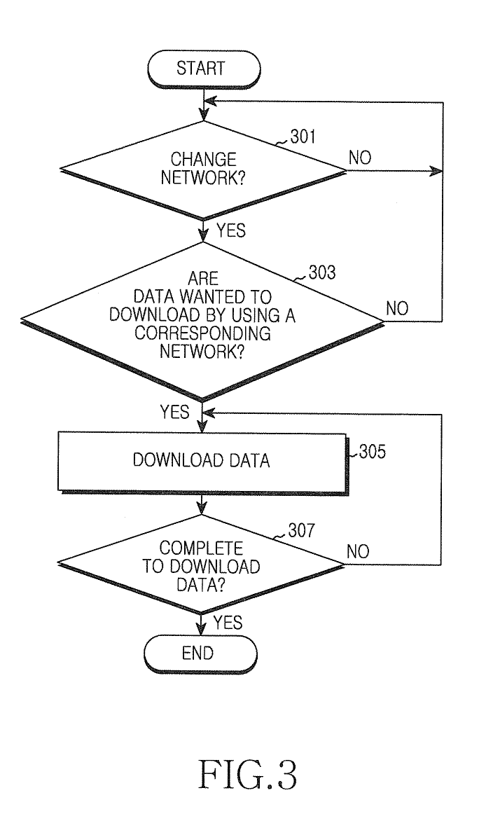

FIG. 3 is a flowchart illustrating a process for a reservation download of data selected by a user in a portable terminal according to the present invention.

Referring to FIG. 3, the portable terminal confirms whether or not a change of a network occurs in block 301. Herein, the change of the network means a situation that the wireless environment currently supported by the portable terminal changes. For example, the change of the network may occur when a user having the portable terminal moves from an area supporting a 3G network to an area supporting a Wi-Fi network, or when a user moves from an area supporting a 3G network to an area supporting a WiBro network, and the like.

If the portable terminal confirms that no change of a network occurs, the portable terminal performs the process in block 301 again.

Alternatively, upon confirming the occurrence of a change of network, the portable terminal proceeds to block 303, confirms the information set up in block 209 of FIG. 2, and confirms whether or not data has been selected to be downloaded by using a corresponding network (a changed network).

If the portable terminal confirms no data has been selected to be downloaded by using a corresponding network in block 303, the portable terminal performs the process in block 301 again.

Alternatively, upon confirming the existence of data selected to be downloaded by using a corresponding network in block 303, the portable terminal proceeds to block 305, and downloads the data selected to be downloaded by a user.

Hereafter, the portable terminal proceeds to block 307 and confirms whether the download of data completes or not.

If the data download is not completed in block 307, the portable terminal performs the process in block 305 again.

Upon confirming that the data download is complete in block 307, the portable terminal stops this algorithm.

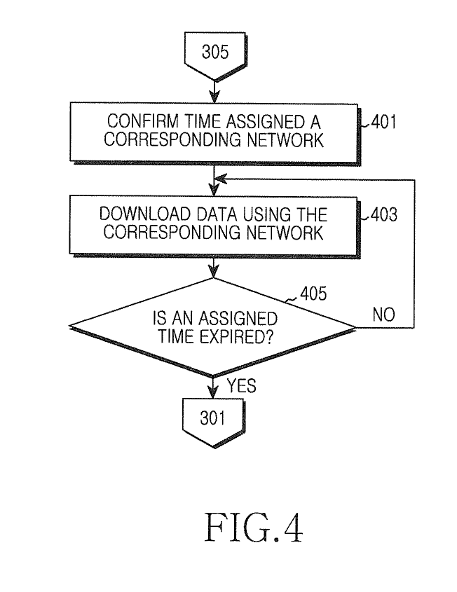

FIG. 4 is a flowchart illustrating a process for downloading data in accordance with networks in a portable terminal according to an embodiment of the present invention.

Referring to FIG. 4, the portable terminal first assumes a state to download data by using a special network like block 305 of FIG. 3.

The portable terminal confirms a download time assigned a corresponding network in block 401. Herein, the download time assigned the corresponding network refers to a user confirming a time selected to download data or the amount of downloading data by using the corresponding network.

Hereafter, the portable terminal proceeds to block 403 and downloads the data using the corresponding network. The portable terminal then proceeds to block 405, and confirms whether the time assigned the corresponding network has expired or not. That is, the portable terminal downloads data for only the time assigned the network, and, after the assigned time has passed, then downloads data via another network selected by a user. This is to prevent one network from being accessed intensively.

Upon confirming that the time assigned the corresponding network has not expired, the portable terminal performs the process in block 403 again.

Upon confirming that the assigned time of the corresponding network has expired in block 405, the portable terminal performs the process in block 301 again.

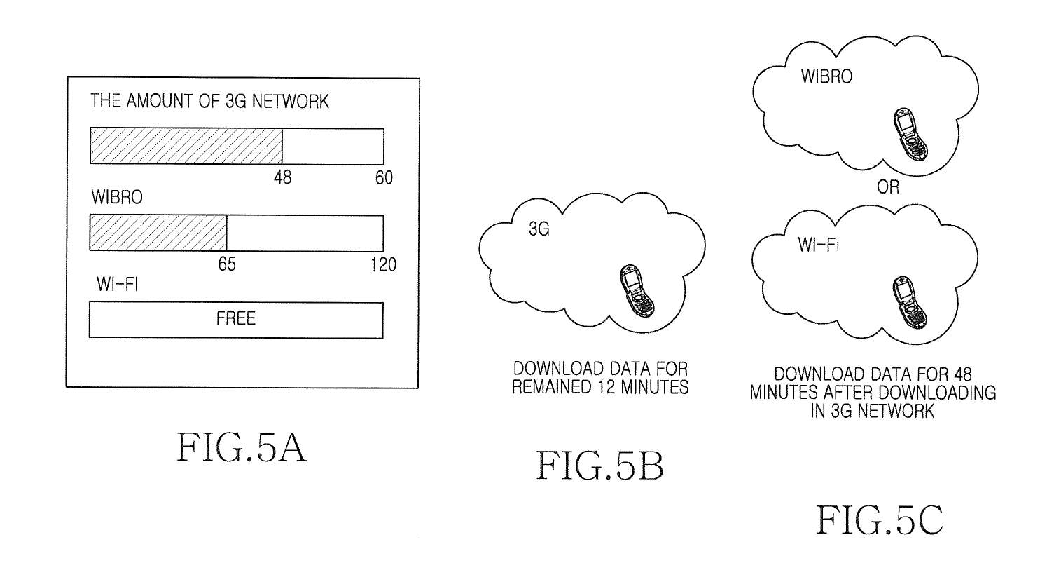

FIG. 5A depicts a screen that displays a list of networks supported by a portable terminal according to an embodiment of the present invention.

Referring to FIG. 5A, the display on the screen indicates that the portable terminal can download data via the 3G network for 60 minutes, and so far, 48 minutes have been used. Likewise, the screen indicates that the portable terminal can download data via the WiBro network for 120 minutes, and so far, 65 minutes have been used. Also, the portable terminal screen indicates that the download of data via a Wi-Fi network is free.

Upon the data reservation download, the portable terminal displays the above-mentioned network list, and can process so as to download data via a network selected by a user.

FIG. 5B illustrates a portable terminal downloading data via networks according to an embodiment of the present invention.

Referring to FIG. 5B, the portable terminal can download data via a network selected by a user by displaying the above-mentioned list upon the reservation download as shown in FIG. 5A.

For example, when a free time for one network is fully used, the portable terminal enables a user to download data via another network. In an embodiment, if a user of the portable terminal would like to download data for fifty (50) minutes, the user can download the data for the entire fifty (50) minutes for free over the WiBro network by confirming the list as shown in FIG. 5A, because the remaining time for free downloading in the WiBro network is fifty-five (55) minutes.

However, if a user wants to first consume the free usage time of the 3G network, the user can download data for twelve (12) minutes via the 3G network, and can download data via the Wi-Fi network or the WiBro network for the remaining thirty-eight (38) minutes.

FIG. 5C illustrates a portable terminal changing a network upon a reservation download according to an embodiment of the present invention.

Referring to FIG. 5C, the portable terminal downloads data for an assigned time by using onel network as shown in FIG. 5B.

If the assigned time is a free time to download data, and a user does not complete the data download during the assigned free time, that is, in case that free time is smaller than a time required for the data download, the user may use another network to download the remaining data. Here, the portable terminal can perform a continuous download in order to download complete data using two or more networks in which downloading services are provided.

When the portable terminal downloads data via only a network selected as in the FIG. 5B, it may incur additional usage charges in accordance with the data download by exceeding the free data amount allotted to the portable terminal to the selected network.

In order to solve above-mentioned problem, the portable terminal can set up a time which allows a user to download data.

After downloading data for a predetermined time, to the portable terminal can continuously download data via another network selected by a user.

The portable terminal downloads data for 12 minutes assigned in FIG. 5B, and can download data for the remaining 48 minutes of a 60 minute period via the WiBro network or the Wi-Fi network as shown in FIG. 5C.

Another embodiment of an apparatus for downloading data in a portable terminal comprises a controller for detecting the change of the network environment in accordance with movement of the portable terminal, and a data download management unit for setting up and managing data per a network which the portable terminal supports, and downloading data after confirming whether data selected to download via a changed network is present or not, and here, the controller processes so as to download data for only an assigned time after confirming a time assigned to a changed network.

As described above, the present invention can prevent a user from incurring unnecessary charges for downloading data by allowing a user to select a network for downloading data using the reservation download function concerning data in the portable terminal.

While the present invention has been particularly shown and described with reference to exemplary embodiments thereof, it will be understood by those skilled in the art that various changes in form and details may be made therein without departing from the spirit and the scope of the present invention as defined by the appended claims.

What is claimed is:

1. An apparatus for downloading data in a portable terminal, comprising:
a controller configured to set up data to download using a network among at least two networks, and process to download the set-up data via the network, wherein the portable terminal is able to download data via the at least two networks.

2. The apparatus of claim 1, further comprising:
a data download management unit configured to confirm whether data is selected to be downloaded via a changed network, when changing a network environment; and
a controller configured to control the data download management unit and process to download data into the changed network, when data is selected to be downloaded via the changed network.

3. The apparatus of claim 2, wherein the data download management unit downloads data for only an assigned time after confirming the assigned time to the changed network.

4. The apparatus of claim 3, wherein the data download management unit confirms whether a change into a network corresponding to a secondary priority of a network used to download data occurs, when the data download is not completed.

5. The apparatus of claim 4, wherein the data download management unit processes so as to perform a continuous data download process via a changed network when the change into the network of the secondary priority occurs.

6. The apparatus of claim 2, wherein the data download management unit sets up a network applied to the data reservation function.

7. The apparatus of claim 6, wherein the data download management unit sets up a network applied to the data reservation function by selecting a network used to download data among an outputted list after outputting the list associated with networks supported in the portable terminal when detecting the data reservation download request.

8. The apparatus of claim 7, wherein the data download management unit outputs data using a network in a network list supported in the portable terminal.

9. The apparatus of claim 6, wherein the data download management unit sets up a plurality of networks applied to the data reservation function.

10. A method of downloading data in a portable terminal, comprising:
setting up data to be downloaded using a network among at least two networks; and
downloading the set up data via the network,
wherein the portable terminal is able to download data via the at least two networks.

11. The method of claim 10, further comprising:
confirming whether data is selected to be downloaded via a changed network, when changing a network environment; and
downloading data into the changed network, when data is selected to be downloaded via the changed network.

12. The method of claim 11, wherein the data downloading via the changed network comprises downloading data for only an assigned time after confirming the assigned time to the changed network.

13. The method of claim 12, wherein the data downloading via the changed network further comprises:
confirming a secondary priority of a network used to download data when not completing the data download after downloading data for only an assigned time; and
confirming whether a network changes into a network of a secondary priority.

14. The method of claim 13, wherein the data downloading via the changed network comprises performing a continuous data download process via a changed network when the change into the network of the secondary priority occurs.

15. The method of claim 11, further comprising:
setting up a network applied to the data reservation function.

16. The method of claim 15, wherein setting up a network applied to the data reservation function comprises:
outputting a list associated with networks supported in the portable terminal; and
selecting a network used to download data among the outputted list.

17. The method of claim 16, wherein outputting a list associated with networks supported in the portable terminal comprises outputting data using a network supported in the portable terminal.

18. The method of claim 15, wherein setting up a network applied to the data reservation function comprises setting up a plurality of networks applied to the data reservation function.

19. An apparatus for downloading data in a portable terminal, comprising:
a controller configured to detect a change of a network environment in accordance with movement of the portable terminal; and
a data download management unit configured to set up and manage data using a network among at least two networks which the portable terminal supports, and download data after confirming whether data selected to be downloaded via a changed network is present or not,
wherein the controller processes so as to download data for only an assigned time.

20. The apparatus of claim 19, wherein the data download management unit processes so as to perform a continuous data download process via the changed network when the change into the network occurs.
